(19) United States
(12) Patent Application Publication
(10) Pub. No.: US 2019/0061728 A1
(43) Pub. Date: Feb. 28, 2019

(54) Brake Fluid Detection System

(71) Applicant: PEACEFUL THRIVING ENTERPRISE CO., LTD., Changhua County (TW)

(72) Inventor: Shih-Hsiang Chien, Changhua County (TW)

(21) Appl. No.: 15/686,141

(22) Filed: Aug. 24, 2017

(51) Int. Cl. B60T 17/22

(52) U.S. Cl. CPC B60T 17/22; B60T 2250/00

(57) ABSTRACT

A brake fluid detection system is a testing system for detecting the brake fluid quality of a brake device. The detection system includes a first device including a detection unit and a communication unit/data transmission unit connected therewith, a second device including a data storage unit, a data analysis unit, and a data processing unit arranged thereon, and a third device including an application software installed thereon. The communication unit/data transmission unit will transfer the raw data detected by the detection unit of the first device to the second device via internet. It employs the third device to correspondingly link to the second device to manage the data and control the data processing unit to generate data and information of the detection. Eventually, it utilizes the third device to display the testing results.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a brake fluid detection system, and more particularly to a system that utilizes communication devices, such as computer or cellphone, to operate for the data of quality of the brake fluid detected, to connect to the cloud database for analysis and to display the testing results for the user through communication devices, such as computer or cellphone.

### Description of Related Arts

Regular vehicle brake requires filling brake fluid. Brake fluid is fluid for hydraulic braking system of vehicle. When a driver steps on the brake paddle, the stepping force from the paddle will be transmitted in the brake system of the vehicle through brake fluid. When we step on the brake paddle, with the aid of a vacuum booster, the master cylinder of brake will be driven to drive the brake fluid. The stepping force will be transmitted to the slave cylinders belongs to the four wheels through the brake fluid. Then the slave cylinders will drive the brake pads to press against the brake rotors so as to generate brake power. However, because regular brake fluid tends to absorb water, if it is not changed and replaced regularly, it can affect the brake performance and cause driving risk. The reason is that when the brake fluid absorbs water, its boil point will decrease, which can cause low braking pressure and affect the braking function.

When the brake system functions, the heat generated by the friction of the brake pad and brake rotor increases the temperature of the system. When the heat reaches the boil point, the water content of the brake fluid will boil and generate bubbles. Because the air can be compressed, when there is a certain amount of bubble in the brake pipeline, the brake power can become insufficient. In serious cases, it can lose brake power.

Therefore, relative dealers have developed several first device of brake fluid. Usually, there is a first device with a detection rod. It can have the detection rod put into a brake fluid tank to utilize its circuit to indicate the data about the water content of the brake fluid. The detected data will be processed by the processor on the device, so as to analyze and find out the test results.

However, there are many types of brake fluid, even the same type of brake fluid may have to apply different parameters to determine its quality because the ingredients of the brake fluids vary. Hence, it has to expand the internal database of the processor to enhance the versatility of the product. However, as the database expands, the cost and size of the first device will increase. Besides, it has to be considered that a user may not understand how to update the database. Therefore, if the database is built on a cloud server and allowed to be connected and updated on the cloud, the first device can remain its original size and cost while having the latest big database. Also, the user does not have to worry about complicated database updating.

### SUMMARY OF THE PRESENT INVENTION

An object of the present invention is to timely provide the user easily accessible brake fluid data, wherein a cloud computing and communication device based on the maturely developed cloud computing and communication of modern technology.

Another object of the present invention is to provide a brake fluid detection system which has the information about various types of brake fluid transmitted to the cloud database via internet for storage and employs cloud computing to process the detected data. It then applies internet connection with cellphone or computer for operation and displaying with the detection results, that achieves an object of accurate and convenient operation.

In order to achieve the above objects, the provides a brake fluid detection system which comprises a first device designed for detecting brake fluid quality. The first device comprises a detection unit and a communication unit/data transmission unit that matches the detection system of the first device. The detection data of the first device will be sent to a third device through the communication unit/data transmission unit. The data will be then sent to a second device via internet through the application software and operation interface installed in the third device. The second device comprises a data storage unit, a data analysis unit, and a data processing unit. The communication unit/data transmission unit will send the quality parameter detected in the fluid tank by the detection unit to the third device, so that the client can operate the operation interface of the application software of the third device to communicate the corresponding data on the first device and the second device. The second device will utilize the data storage unit and collect the parameter data related to the brake fluid quality, utilize the data analysis unit to conduct quality parameter analysis, and utilize the data processing unit to generate detection data and information for the third device to display to the user.

The second device can be a cloud server. The application software of the third device corresponds to the data of the detection unit of the first device and serves the transmission of the data to the second device. The second device stores the raw data of the detection unit and obtains the raw data of the detection unit for data analysis through the connection between the processing unit and the data storage unit. The processing unit matches the detection signal provided by the first device, utilizes the raw data acquired by the detection unit to generate the data and information of brake fluid quality, and then has the third device display the data and information to the user.

The second device acquires the type and brand of the brake fluid that the user demands through the third device and identifies the corresponding data of the quality of the type of brake fluid. The data storage unit of the second device will simultaneously utilize the third device to receive the parameters of the fluid quality acquired from the first device. The parameters of the fluid will be analyzed by the data analysis unit thereof.

The parameters are calculated for comparing with the data of quality in the database by the data processing unit so as to obtain the test results. The test results will eventually be sent back to the third device, so as for displaying to the user to disclose information of the test results through the operation interface of the third device.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of the structure of a preferred embodiment of the present invention.

FIG. 2 is a perspective view of an operation interface of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

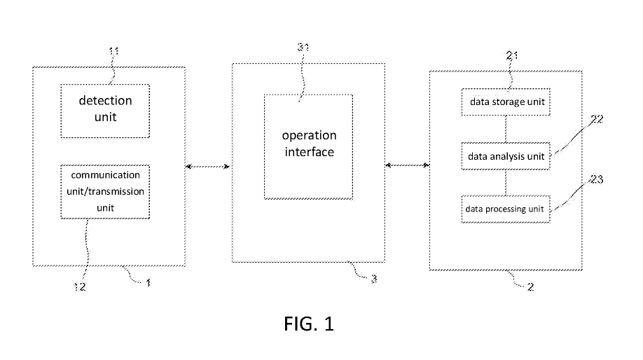

Referring to FIG. 1, a brake fluid detection system according to a preferred embodiment is illustrated, which comprises a first device 1 that comprises a detection unit 11 and a communication unit/data transmission unit 12 connected therewith, a second device 2, and a third device 3. The detection unit 11 is a structure with probe and sensing circuit to contact and detect the brake fluid.

The second device 2 comprises a data storage unit 21, a data analysis unit 22, and a data processing unit 23.

The third device 3 has an application software for the detection of brake fluid information, which comprises an operation interface 31. The communication unit/data transmission unit 12 will link the information obtained through the detection in the fluid tank by the detection unit 11 and send it to the third device 3 via internet. The information will be sent to the second device 2 through the third device 3 for data extraction and processing to be corresponded to the first device 1 through the operation interface 31. The second device 2 utilizes the third device 3 to corresponding connect to the detection unit 11 and to interactively match the information of the detection unit 11 through the use of the operation interface 31. The data storage unit 21 of the second device 2 collects the information related to all types of oil products and oil companies. The data analysis unit 22 conducts analysis with the raw data and the information in the data storage unit 21. Then the data processing unit 23 generates data and information of the detection for displaying to the client.

In detail, the third device 3 utilizes the internet to link the information of the first device 1 to the second device 2. The application software of the third device 3 has an operation interface 31 arranged thereon. The operation interface 31 is displayed on the third device 3. In other words, when the application software is selected on the third device 3, it will provide operation interface 31 for the operations and functions, so as for the connection and data interaction to the first device 1 and the second device 2.

The application software preinstalled on the third device 3 is installed on a communication device or computer to correspondingly link to the detection unit 11 of the first device 1 and to utilize the network of the third device 3 to build a connection to the second device 2 for analyzing the raw data of the detection unit 11. The information of the oil products and brands is prestored in the data storage unit 21 of the second device 2, such that the data analysis unit 22 can utilize the information and have the data processing unit 23 connected therewith process the data obtained from the first device 1. Then the data and information of brake fluid quality, comprising the proportion of water of the brake fluid, can finally be generated and sent to the third device 3 via the internet, so as to be displayed to the client of the detection through the third device 3.

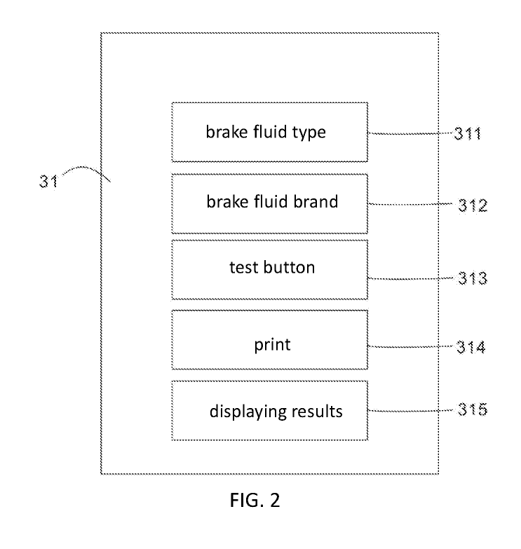

Referring to FIG. 2, the operation interface of the third device 3, which is able to achieve the above objects, according to the present invention, comprises selection of brake fluid type 311, selection of brake fluid brand 312, test button 313, print button 314, displaying results button 315, wherein information of the operation interface 31 correspondingly links to the application software of the first device 1. Accordingly, when the user executes the detection, he or she can first utilize the operation interface 31 to link to the first device 1 and then conduct the detection process and function of display through the operation interface 31, so as for the user to fast operate the system and obtain detail detection information.

According to the above mentioned embodiment, the user can press the selection of brake fluid type 311 and the selection of brake fluid brand 312 on the operation interface 31 so as to select the type and brand of the brake fluid for the detection. Then he can press the connection button (not shown on the figures) for connecting to the communication unit/data transmission unit 12 of the first device 1, insert the detection unit 11 of the first device 1 into the fluid tank, and press the test button 313 on the operation interface 31 of the third device 3 to command the circuit of the detection unit 11 of the first device 1 to obtain the parameters of the quality of the oil product. The detection unit 11 will send the detected parameters of the brake fluid to the communication unit/data transmission unit 12. The communication unit/data transmission unit 12 will then transmit the parameters to the third device 3 via wireless network. The third device 3 is connected to the second device 2 through internet and sends the parameters to second device 2 for raw data processing. Eventually, the user can press the displaying results button 315 to command the second device 2 to transmit the data and information of the fluid quality to the third device. The third device 3 then displays the detection results. If the user feels like to print the information, he can press the print button 314 to print the detection results.

Based on the above technology of the present invention, it can overcome the issue that conventional device cannot select oil product for optional analysis, so as to achieve the utility and non-obviousness of the above advantages of the present invention.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A brake fluid detection system for detecting brake fluid water content, comprising:
a first device comprising a detection unit and a communication unit/data transmission unit, wherein said detection unit is connected with said communication unit/data transmission unit, wherein said detection unit is a probe for being the structure of contacting and detecting the brake fluid;
a second device, comprising a data storage unit, a data analysis unit, and a data processing unit; and
a third device having an application software for detection, wherein said application software comprises an operation interface, wherein said second device is a cloud server, wherein said third device is a device selected from the group consisting of a communication device and a computer, wherein said third device utilizes the operation interface thereof to conduct corresponding connection to said detection unit of said first device via wireless network for detecting data of brake fluid and sends the data to said second device through the internet via said third device, wherein said second device store the data of brake fluid of said detection unit, wherein the data of brake fluid of said detection unit obtained by said second device is received and stored by said data storage unit and sent to said data analysis unit for analysis, wherein the analyzed data will be sent to said processing unit for data processing so as to generate data and information of brake fluid quality, wherein the data and information are sent to said third device via internet for displaying to the user.

2. The brake fluid detection system, as recited in claim 1, wherein said operation interface comprises a brake fluid type selection, a brake fluid brand selection, a test button, a print, and displaying results.

3. The brake fluid detection system, as recited in claim 1, wherein said data storage unit of said second device collects information of all kinds of oil products and oil product companies, wherein said data analysis unit analyzes raw data with the information of said data storage unit, wherein said data processing unit generates data and information of the detection for displaying to the user.

4. The brake fluid detection system, as recited in claim 1, wherein said detection unit has a sensing circuit connected to said probe.
